(19) United States
(12) Patent Application Publication
(10) Pub. No.: US 2023/0155328 A1
(43) Pub. Date: May 18, 2023

(54) HIGH-SPEED ELECTRICAL CONNECTOR

(71) Applicant: SAMTEC, INC., New Albany, IN (US)

(72) Inventor: Jonathan E. BUCK, Hershey, PA (US)

(21) Appl. No.: 17/995,514

(22) PCT Filed: Apr. 8, 2021
(86) PCT No.: PCT/US2021/026360

§ 371 Date: Oct. 5, 2022

Related U.S. Application Data
(60) Provisional application No. 63/006,960, filed on Apr. 8, 2020.

(51) Int. Cl. H01R 13/6595; H01R 13/6586; H01R 13/6584

(52) U.S. Cl. CPC H01R 13/6595; H01R 13/6586; H01R 13/6584

(57) ABSTRACT

A high-speed electrical RF, single-ended, or differential/twin axial electrical connector, capable of at least 67 GHz of operable bandwidth. The electrical connector can include at least one signal conductor that is supported by a connector housing that, in turn, is received by an electrical shield. Two such electrical connectors are configured to mate with each other, such that a third electrical shield at least partially surrounds and contacts each of the first and second electrical shields, thereby placing the electrical shields in electrical communication with each other.

### CROSS-REFERENCE TO RELATED APPLICATIONS

This claims priority to U.S. Patent Application Ser. No. 63/006,960 filed Apr. 8, 2020, the disclosure of which is hereby incorporated by reference as if set forth in its entirety.

### BACKGROUND

### Technical Field

This disclosure generally relates to high-speed electrical interconnects, such as RF (radio frequency/single-ended) interconnects and differential signal interconnects.

### Brief Description of Other Technical Approaches

U.S. Pat. Nos. 4,571,014; 5,114,364; 5,197,893; 5,334,050; 5,397,241; 5,507,655; 5,632,634; 5,842,872; 6,464,537; 6,899,566; 7,004,793; 7,048,585; 7,485,001; 7,553,187; 7,927,144; 9,071,001; 10,038,282 and 10,333,237 are hereby incorporated by reference in their entireties.

US Patent Publication Nos. 2010/0009571; 2010/0144201 and 2019/0334292 are hereby incorporated by reference in their entireties.

ISORATE brand RF jacks and RF cable connectors, all commercially available from SAMTEC, Inc., New Albany, Ind., are hereby incorporated by reference in their entireties.

### SUMMARY

An electrical connector system can include a first electrical signal conductor surrounded on at least three sides by a first shield, a second electrical signal conductor surround on at least three sides by a second shield, and a third shield that surrounds at least three sides of the first shield and at least three sides of the second shield. An electrical connector system can include a first electrical signal conductor surrounded on at least four sides by a first shield, a second electrical signal conductor surround on at least three or at least four sides by a second shield, and a third shield that surrounds at least three sides or at least four sides of the first shield and at least three sides or at least four sides of the second shield.

The first electrical signal conductor can include a first conductor mating portion and a first conductor mounting portion. The second electrical signal conductor can include a second conductor mating portion and a second conductor mounting portion. The first shield can include a first shield mounting portion and a first shield mating portion. The second shield can include a second shield mounting portion and a second shield mating portion. A sealing gasket can be positioned between the first shield and the second shield, such as between a butt coupled first shield mating portion and a second shield mating portion. The first shield and the second shield can be at least partially butt coupled at one of their respective ends. A sealing gasket can be positioned where the first shield and the second shield are each butt coupled to one another. The third shield can define a first third shield mating portion and a second third shield mating portion.

The first shield can define a first tubular shape. The second shield can define a second tubular shape. The third shield can define a third tubular shape. The third shield can receive, at two opposed ends thereof, the first shield and the second shield. The first electrical signal conductor can define a first length that is surrounded by a combination of the first shield and the third shield. The second electrical signal conductor can define a second length that is surrounded by a combination of the second shield and the third shield. A housing can at least partially surround the first shield and the third shield. A solder charge, such as a first electrical signal conductor SMT attachment attached to the first electrical signal conductor, when reflowed onto a substrate, has a non-spherical cross-sectional shape.

Other aspect disclosed herein include a coaxial substrate comprising SMT pads, a method to match impedance that includes a step of reducing pad via stub length, a method to match impedance that includes a step of reducing pad via stub to approximately 0.5 mm to 4 mm, a method to match impedance that include a step of flooding the ground pads of a substrate, and a method to match impedance that includes a step of reducing a width and depth of a solder ball, without reducing or increasing a height of the solder ball.

Also included is an electrical connector that includes a single-ended signal conductor, differential signal conductors, or both that is capable of −60 dB or better of unwanted cross-talk through a 75 GHz and/or 0 dB through −3 dB (or better) of insertion loss through 75 GHz.

### BRIEF DESCRIPTION OF THE DRAWINGS

FIG. 1A is perspective view of an electrical connector system including a first electrical connector and a second electrical connector shown mated to the first electrical connector, wherein portions of the first and second electrical connectors are removed for illustration purposes;

FIG. 1B is a perspective view of the electrical connector system of FIG. 1A, showing the first and second electrical connectors including a first electrical shields, respectively;

FIG. 1C is another perspective view of the electrical connector system of FIG. 1B, showing the first and second electrical connectors including a first electrical shields, respectively;

FIG. 1D is a sectional side elevation view of the electrical connector system of FIG. 1B, taken along line 1D-1D;

FIG. 1E is a perspective view of the electrical connector system of FIG. 1B, showing a sealing gasket disposed between the first and second electrical shields;

FIG. 1F is a perspective view of the electrical connector system of FIG. 1B, shown including a third electrical shield;

FIG. 1G is a sectional side elevation view taken along line 1G-1G of FIG. 1F;

FIG. 2A is a perspective view of a substrate configured to be mounted to one of the first and second electrical connectors of FIG. 1E;

FIG. 2B is a perspective view of the substrate of FIG. 2A, but showing a mounting substrate mating interface flooded with a ground plane material;

FIG. 2C is a perspective view of a step of fabricating the substrate illustrated in FIG. 2B;

FIG. 2D is a perspective view of a further step of fabricating the substrate illustrated in FIG. 2B;

FIG. 2E is a cross-sectional view of a solder ball of a plurality of solder balls configured to be attached to mounting ends of electrical signal conductors and electrical shields of the first and second electrical connectors of FIG. 1E;

FIG. 2F is a cross-sectional view of a conventional solder ball;

FIG. 2G is a chart plotting impedance as a function of time to illustrate the single ended impedance profile of electrical connectors incorporating surface mount technology improvements;

FIG. 3 is a perspective view of a plurality of electrical connector systems of FIG. 1E; and

FIG. 4A is a perspective view of a plurality of electrical connector systems that includes a first single-ended electrical connector mated to a second single-ended electrical connector; and

FIG. 4B is an enlarged cross-sectional view of a portion of the electrical connector system of FIG. 4A, showing a pair of mated electrical signal conductors of the first and second electrical connectors.

### DETAILED DESCRIPTION

Electrical connectors having electrical signal conductors that can be single-ended signal or can differential signal pairs can be, according to S-parameter modeling, capable of transferring data signals at up to 75 GHz, including up to 67 GHz, at cross-talk levels of −60 dB or less, having insertion losses between 0 dB through −3 dB or better.

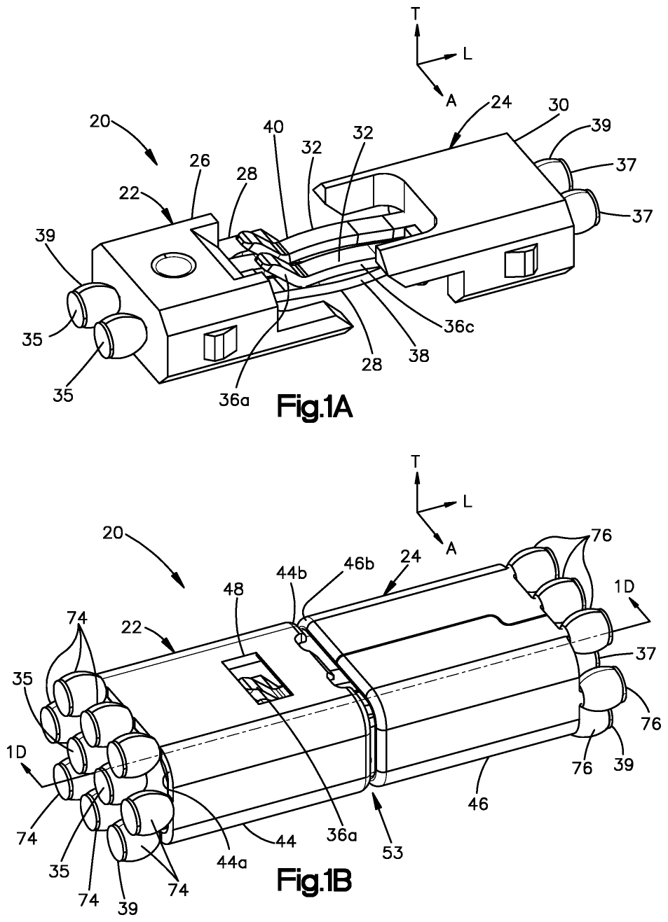

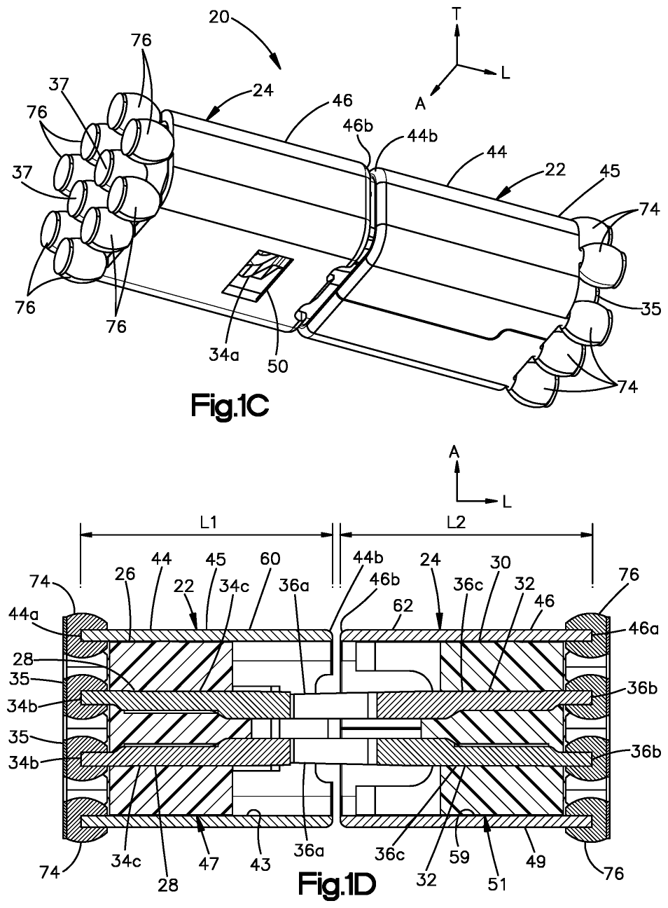

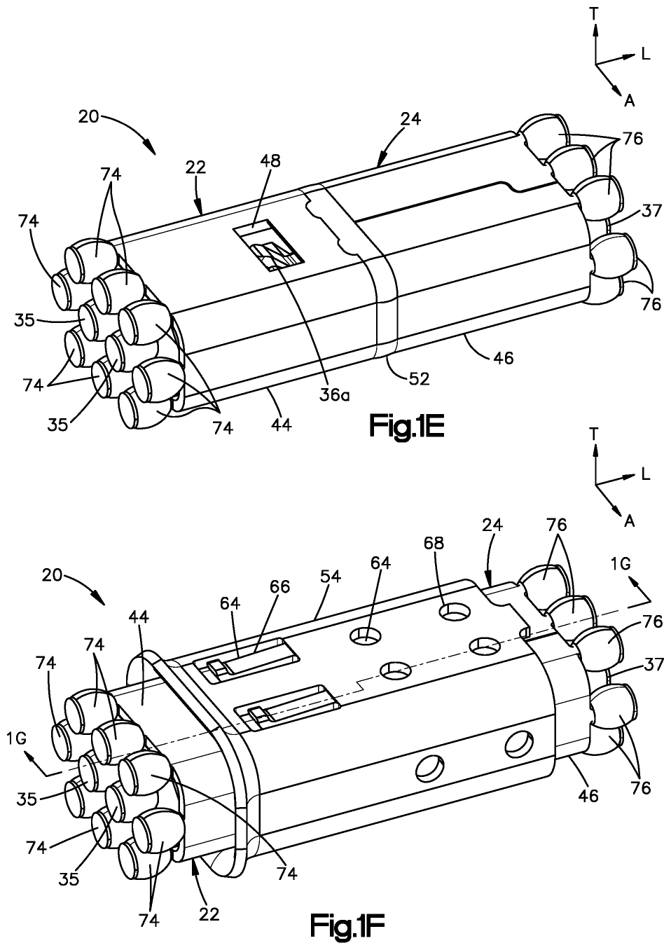

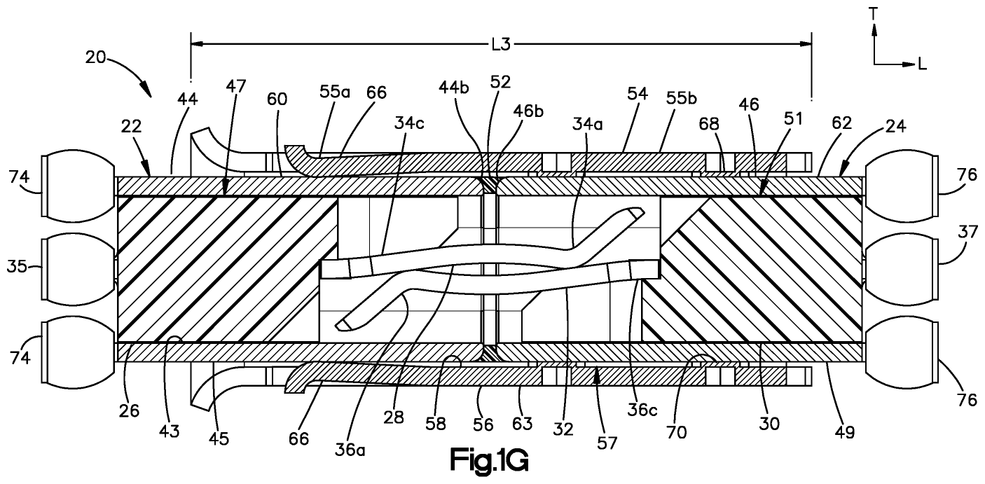

Referring to FIGS. 1A-1D, an electrical connector system 20 in one example can include a first electrical connector 22 and a second electrical connector 24 configured to mate with each other so as to place the first and second electrical connectors 22 and 24 in electrical communication with each other. The first electrical connector 22 can include a dielectric or electrically insulative first connector housing 26 and at least one first electrical signal conductor 28 such as a pair of first electrical signal conductors 28 supported by the first connector housing 26. It should be appreciated, of course, that the first electrical connector 22 can include any number of first electrical signal conductors 28 as desired. In one example, the at least one first electrical signal conductor 28 can be insert molded in the first connector housing 26. Alternatively, the at least one first electrical signal conductor 28 can be stitched into the first connector housing 26.

The second electrical connector 24 can similarly include a dielectric or electrically insulative second connector housing 30 at least one second electrical signal conductor 32 such as a pair of electrical signal conductors 32 supported by second connector housing 30. the first such as a plurality of second electrical signal conductors. It should be appreciated, of course, that the second electrical connector 24 can include any number of second electrical signal conductors 32 as desired. In one example, the at least one second electrical signal conductor 32 can be insert molded in the second connector housing 30. Alternatively, the at least one second electrical signal conductor 32 can be stitched into the first connector housing 30.

The first and second electrical connectors 22 and 24 can be mated with each other in respective mating directions that are oriented along a longitudinal direction L. The first and second electrical connectors 22 and 24 can be mated with each other so as to define a separable interface that allows for the first and second electrical connectors 22 and 24 to be unmated with each other without damaging or destroying either of the electrical connectors. Thus, the first and second electrical connectors 22 and 24 can be mated with each other or any other suitable electrical connector after being unmated from each other. The first and second electrical connectors 22 and 24 can be unmated with each other in respective unmating directions that are opposite the mating directions and thus oriented along a longitudinal direction L.

When the first and second signal conductors 28 and 32 define respective pairs of signal conductors, the first electrical signal conductors 28 of the pair of first signal conductors 28 can be aligned with each other along a lateral direction A that is perpendicular to the longitudinal direction L. In one example, the first electrical signal conductors 28 of the pair of first signal conductors 28 can define a first differential signal pair. Further, the first electrical signal conductors 28 can be edge coupled. In particular, the first electrical signal conductors 28 define respective opposed edges and respective opposed broadsides in a plane oriented perpendicular to the longitudinal direction that intersects the first electrical signal conductors 28. The edges can be shorter than the broadsides in the plane. The edges of the first electrical signal conductors 28 can face each other in an edge coupled configuration. Alternatively, the first electrical signal conductors 28 can be broadside coupled wherein the respective broadsides face each other.

Further, the second signal conductors 32 of the pair of second signal conductors 32 can be aligned with each other along the lateral direction A. In one example, the second electrical signal conductors 32 of the pair of second signal conductors 32 can define a second differential signal pair. Further, the second electrical signal conductors 32 can be edge coupled. In particular, the second electrical signal conductors 32 define respective opposed edges and respective opposed broadsides in a plane oriented perpendicular to the longitudinal direction that intersects the second electrical signal conductors 32. The edges can be shorter than the broadsides in the plane. The edges of the second electrical signal conductors 32 can face each other in an edge coupled configuration. Alternatively, the second electrical signal conductors 32 can be broadside coupled wherein the respective broadsides face each other.

Whether the first and second signal conductors 28 and 32 define one respective signal conductor ore more than one respective signal conductor, the respective first and second electrical connectors 22 and 24 can define respective widths along the lateral direction A. The first and second electrical connectors 22 and 24 can define respective heights along a transverse direction T that is perpendicular to each of the longitudinal direction L and the lateral direction A. The width of the first electrical connector 22 can be greater than the height of the first electrical connector 22. Similarly, the width of the second electrical connector 24 can be greater than the height of the second electrical connector 24.

The first signal conductor 28 and the at least one second signal conductor 32 can each be made from copper, a noble metal, a metal alloy, any combination of copper, a noble metal and a metal alloy, or any suitable alternative electrically conductive material. The first signal conductor 28 can define a first conductor mating portion 34a (see FIG. 1G), a first conductor mounting portion 34b opposite the first conductor mating portion 34a, and a first intermediate portion 34c that extends from the first conductor mating portion 34a to the first conductor mounting portion 34b. In one example, the first signal conductor 28 can be configured as a vertical conductor whereby the first conductor mating portion 34a and the first conductor mounting portion 34b are aligned with each other along the longitudinal direction L. Alternatively, the first signal conductor 28 can be configured as a right-angle conductor whereby the first conductor mating portion 34a and the first conductor mounting portion 34b are oriented perpendicular with respect to each other. A first signal conductor solder ball, a first electrical signal conductor solder charge or any other first electrical signal conductor surface mount technology (SMT) attachment 35 (such as a J-lead, a solder pillar commercially available from International Business Machine (IBM) having a place of business in Armonk, N.Y., or the like) can be attached to the first conductor mounting portion 34b of the first signal conductor 28. In one example, the first signal conductor SMT attachment 35 is configured as a solder ball 39. The at least one first conductor mounting portion 34b can have a corresponding at least one first retention portion that intersects the solder ball 39 and retains the solder ball 39 on the corresponding at least one first electrical conductor 28.

Similarly, the second signal conductor 32 can define a second conductor mating portion 36a, a second conductor mounting portion 36b opposite the second conductor mating portion 36a, and a second intermediate portion 36c that extends from the second conductor mating portion 36a to the second conductor mounting portion 36b. In one example, the second signal conductor 32 can be configured as a vertical conductor whereby the second conductor mating portion 36a and the second conductor mounting portion 36b are aligned with each other along the longitudinal direction L. Alternatively, the second signal conductor 32 can be configured as a right-angle conductor whereby the second conductor mating portion 36a and the second conductor mounting portion 36b are oriented perpendicular with respect to each other. A second signal conductor solder ball, a second electrical signal conductor solder charge or any other second electrical signal conductor SMT attachment 37 (such as a J-lead, IBM solder pillar, or the like) can be attached to the second conductor mounting portion 36b of the second signal conductor 32. In one example, the second electrical signal conductor SMT attachment 37 is configured as a solder ball 39. The at least one first conductor mounting portion 34 can have a respective second retention portion that intersects the solder ball 39 and retains the solder ball 39 on the corresponding at least one second electrical conductor 32.

During operation, when the first and second electrical connectors 22 and 24 are mated with each other, the respective first and second mating portions 34a and 36a define a mating interface, wherein the first and second mating portions 34a and 36a ride along each other until the first and second electrical connectors 22 and 24 are fully mated with each other. When the first and second electrical connectors 22 and 24 are fully mated, the first and second electrical conductors 34 and 36 are in physical contact with each other and electrical communication with each other, such that electrical signals can be transmitted between the respective first and second electrical conductors 28 and 32.

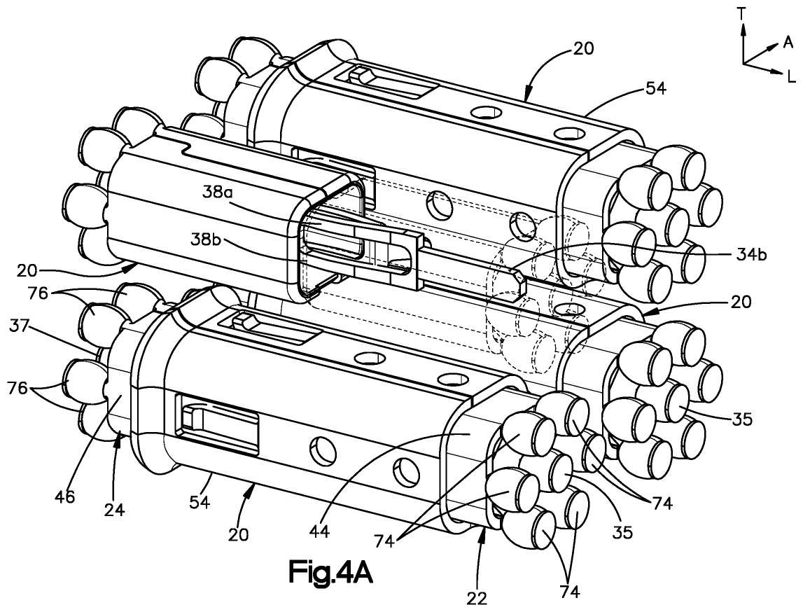

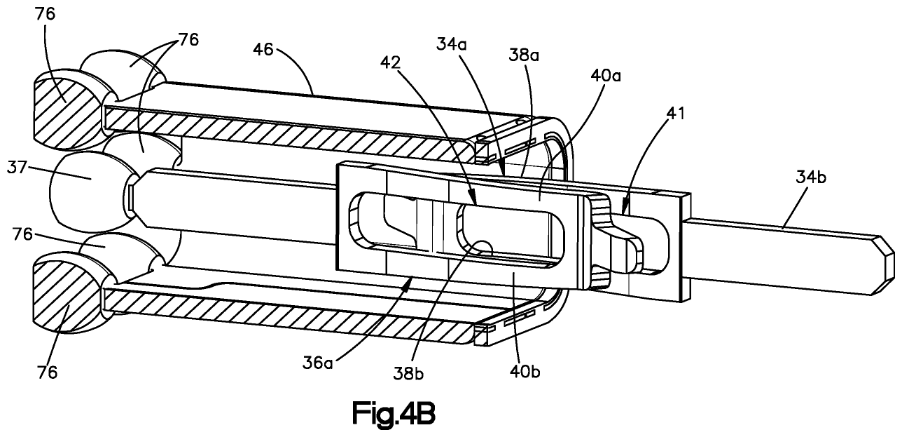

In one example, the first and second mating portions 34a and 36a can be hermaphroditic. Further, the first and second mating portions 34a and 36a can be solid along respective entireties of their respective lengths. In other words, no air gaps exist in the mating portions 34a and 36a in cross-section along respective planes that are oriented perpendicular to the longitudinal direction L, when the planes travel along the entire respective lengths of the first and second mating portions 34a and 36a. The first conductor mating portion 34a can define at least one first beam 38 such as one single first beam 38 shown in FIG. 1A or two first beams 38a and 38b that are spaced from each other as shown in FIG. 4B. The two first beams 38a and 38b can be spaced from each other along the lateral direction A so as to define a first air gap 41 that can be defined between the at least two first beams 38a and 38b. Similarly, the second conductor mating portion 36a can define at least one second beam 40 such as a single second beam 40 as shown in FIG. 1A or two second beams 40a and 40b as shown in FIG. 4B. The two second beams 40a and 40b can be spaced from each other along the lateral direction A so as to define a second air gap 42 that can be defined between the at least two second beams 40a and 40b.

The at least one first beam 38a can electrically connect, physically touch, or both with the corresponding at least one second beam 38b when the first and second electrical connectors 22 and 24 are mated with each other. In one example, the first mating portions 34a and 36a can releasably connect to each other when the first and second electrical connectors 22 and 24 are mated with each other, thereby defining a separable mating interface. The electrical signal conductors 28 and 32 illustrated in FIG. 4B can be single ended or can define radiofrequency (RF) conductors, but can alternatively define differential signal conductors as desired as described above with respect to FIGS. 1A-1D. Alternatively, the electrical conductors 28 and 32 of FIGS. 1A-1D can be configured as single-ended or RF conductors as desired. In this regard, the first signal conductors 28 and second signal conductors 32 can define a single-ended configuration, an edge-coupled differential signal pair, a hermaphroditic differential signal pair, a beam-on-beam differential pair, or any combination thereof. The two first signal conductors 28 can be identical to each other, as shown, or may be visually different from one another. For example, one of the two first signal conductors 28 can be a first signal conductor 28 of a first pair of signal conductors, and the other one of the two first signal conductors 28 can be a second signal conductor 28 of the first pair of signal conductors. Similarly, the two second signal conductors 32 can be identical to each other, as shown, or may be visually different from one another. For example, one of the two second signal conductors 32 can be a second signal conductor 32 of a second pair of signal conductors, and the other one of the two second signal conductors 32 can be a second signal conductor 32 of the second pair of signal conductors.

With continuing reference to FIGS. 1A-1D, the first electrical connector 22, and thus the electrical connector system 20, can further include a first electrical shield 44. In one example, the first electrical shield 44 can be electrically conductive. For instance, the first electrical shield 44 can be metallic. Alternatively or additionally, the first electrical shield 44 can include a magnetic absorbing material, such as a lossy material. In some examples, the first electrical shield 44 can be made from copper, a noble metal, a metal alloy, any combination of copper, a noble metal and a metal alloy, electrically conductive carbon or any electrically conductive or magnetic absorbing material.

The first shield 44 can be carried or supported by the first connector housing 26. For instance, the first shield 44 can receive the first connector housing 26. The first electrical shield 44 can have a first length L1 along the longitudinal direction L. The at least one first signal conductor 28 can be at least partially surrounded on at least three sides by the first shield 44 along all or any portion of the first length L1 of the first shield 44. In one example, the at least one first signal conductor 28 can be surrounded on all sides along all or any portion of first length L1 of the first shield 44. Thus, in a plane that is oriented perpendicular to the longitudinal direction L and intersects the at least one first signal conductor 28, the first shield 44 can define an enclosed first perimeter that fully circumscribes or surrounds the at least one first signal conductor 28 at least at one location along the first length L1 of the first shield 44. In some examples, the at least one first signal conductor 28 can be surrounded all sides along an entirety of the first length L1 of the first shield 44. The first length L1 of the first shield 44 can span the intermediate portion 34c of the at least one first signal conductor 28. The first conductor mating portion 34a and the first conductor mounting portion 34b can extend out with respect to the first shield 44 along the longitudinal direction L.

The first shield 44 can be configured as a first sleeve 45 having a first internal surface 43 that defines a first internal void 47 that can extend through an entirety of the first sleeve 45 along the longitudinal direction L. The first shield 44 defines a first external surface 60 that is opposite the first internal surface 43. The first internal void 47 is sized to accept therein the at least one first signal conductor 28 shown in FIG. 1A. In particular, the first internal void 47 can be sized to receive the first connector housing 26 that supports the at least one first signal conductor 28. The first shield 44 can define a first tubular cross-sectional shape, a square cross-sectional shape having rounded corners, a rectangular cross-sectional shape having rounded corners, a circular cross-sectional shape, a rectangular cross-sectional shape, a square cross-sectional shape, or any suitable alternative cross-sectional shape.

The first shield 44 can further include a first relief window 48 that extends through the first sleeve 45 at a location aligned along the transverse direction T with the first conductor mating portion 34a of the at least one first electrical conductor 28. As the first conductor mating portion 34a rides along the second conductor mating portion 36a during mating of the first and second electrical connectors 22 and 24, the first conductor mating portion 34a can resiliently deflect away from the second conductor mating portion 36a along the transverse direction T. The first conductor mating portion 34a can deflect toward, and in some instances into, the relief window 48 to prevent the first conductor mating portion 34a from contacting the first shield 44 as the first and electrical connectors 22 and 24 are mated with each other.

Similarly, the second electrical connector 24, and thus the electrical connector system 20, can further include a second electrical shield 46. In one example, the second electrical shield 46 can be electrically conductive. For instance, the second electrical shield 44 can be metallic. Alternatively or additionally, the second electrical shield 46 can include a magnetic absorbing material, such as a lossy material. In some examples, the second electrical shield 46 can be made from copper, a noble metal, a metal alloy, any combination of copper, a noble metal and a metal alloy, electrically conductive carbon or any electrically conductive or magnetic absorbing material.

The second shield 46 can be carried or supported by the second connector housing 30. For instance, the second shield 46 can receive the second connector housing 30. The second electrical shield 46 can have a second length L2 along the longitudinal direction L. The at least one second signal conductor 32 can be at least partially surrounded on at least three sides by the second shield 46 along all or any portion of the second length L2 of the second shield 46. In one example, the at least one second signal conductor 32 can be surrounded on all sides along all or any portion of second length L2 of the second shield 46. Thus, in a plane that is oriented perpendicular to the longitudinal direction L and intersects the at least one second signal conductor 32, the second shield 46 can define an enclosed second perimeter that fully circumscribes or surrounds the at least one second signal conductor 32 at least at one location along the second length L2 of the second shield 46. In some examples, the at least one second signal conductor 32 can be surrounded all sides along an entirety of the second length L2 of the second shield 46. The second length L2 of the second shield 46 can span the intermediate portion 36c of the at least one second signal conductor 32. The second conductor mating portion 36a and the first mounting portion 36b can extend out with respect to the second shield 46 along the longitudinal direction L.

The second shield 46 can be configured as a second sleeve 49 having a second internal surface 59 that defines a second internal void 51, and a second external surface 62 opposite the second internal surface 59. The second internal void 51 can extend through the sleeve 49 along an entirety of the second length L2. The second internal void 51 is sized to accept therein the at least one second signal conductor 30 shown in FIG. 1A. The second internal void 51 can be sized to receive the second connector housing 30. The second shield 46 can define a second tubular cross-sectional shape, a square cross-sectional shape having rounded corners, a rectangular cross-sectional shape having rounded corners, a circular cross-sectional shape, a rectangular cross-sectional shape, a square cross-sectional shape, or any suitable alternative cross-sectional shape.

The second shield 46 can further include a second relief window 50 that extends through the second sleeve 49 at a location aligned along the transverse direction T with the second conductor mating portion 36a of the at least one second electrical conductor 32. As the second conductor mating portion 36a rides along the first conductor mating portion 34a during mating of the first and second electrical connectors 22 and 24, the second conductor mating portion 36a can resiliently deflect away from the first conductor mating portion 34a along the transverse direction T. Thus, the deflection of the second conductor mating portion 36a can be opposite the deflection of the first conductor mating portion 34a along the transverse direction T. The second conductor mating portion 36a can deflect toward, and in some instances into, the second window 50 to prevent the second conductor mating portion 36a from contacting the second shield 46 as the first and electrical connectors 22 and 24 are mated with each other.

When the first and second electrical connectors 22 and 24 are mated with each other, the first shield 44 and the second shield 46 can be aligned with each other along the longitudinal direction L. However, in one example, the first and second shields 44 and 46 remain spaced from each other along the longitudinal direction L in their respective entireties. That is, the first electrical shield 44 can define a first shield mounting portion 44a and a first shield mating portion 44b opposite the first shield mounting portion 44a along the longitudinal direction L. Similarly, the second electrical shield 46 can define a second shield mounting portion 46a and a second shield mating portion 46b opposite the second shield mounting portion 46a along the longitudinal direction L. The first and second shield mounting portions 44a and 46a can face each other and are spaced away from each other along the longitudinal direction L so as to define a gap 53 therebetween. Air can therefore separate immediately adjacent first and second electrical shields 44 and 46 of first and second electrical connectors 22 and 24 that are mated with each other. The first and second shield mounting portions 44a and 46a can define respective terminal ends of the first and second shields 44 and 46. The first conductor mating portion 34a can extend beyond the first shield mating portion 44b of the first shield 44 along the longitudinal direction L. Similarly, the second conductor mating portion 36a can extend beyond the second shield mating portion 46b of the second shield 46 along the longitudinal direction L.

The first shield 44 the second shield 46 can be butt coupled when the first and second electrical connectors 22 and 24 are mated to each other, such that the first shield mating portion 44b of the first shield 44 and the second shield mating portion 46b of the second shield 46 do not overlap one another as described in more detail below. Stated another way, the first shield 44 is not received within the second shield 46 when the first and second electrical connectors 22 and 24 are mated with each other, and the second shield 46 is not received within the first shield 44 when the first and second electrical connectors 22 and 24 are mated with each other.

In one example, the first and second shields 44 and 46 are physically isolated from each other such that they do not physically touch each other when the first and second electrical connectors 22 and 24 are mated with each other. In particular, the first and second shields 44 and 46 can be spaced from each other along the longitudinal direction L. Further, the first and second shields 44 and 46 can be configured such that they do not overlap each other in either the transverse direction T or the lateral direction A. Thus, no plane exists that 1) is oriented in the transverse direction T and the lateral direction A (or perpendicular to the longitudinal direction L), and 2) passes through any respective portions of both the first shield 44 and the second shield 46. Otherwise stated, a plane that is oriented in the transverse direction T and the lateral direction A (or perpendicular to the longitudinal direction L) and disposed between the first and second mounting portions 44a and 46a does not pass through any portion of the first electrical shield 44, and further does not pass through any portion of the second electrical shield 46.

Furthermore, in some examples, the first shield 44 can be the only ground member of the first electrical connector 22. That is, the first electrical connector 22 does not include any discrete ground conductors. Similarly, in some examples, the second shield 46 can be the only ground member of the second electrical connector 24. That is, the second electrical connector 24 does not include any discrete ground conductors. Thus, in some example, no grounds of the first electrical connector 22 touch any grounds of the second electrical connector 24 when the first and second electrical connectors 22 and 24 are mated with each other. Otherwise stated, when the first and second electrical connectors 22 and 24 are mated with each other, the first electrical connector 22 has no grounds that are 1) supported directly by the first connector housing 26 and 2) in direct electrical communication with any grounds of the second electrical connector 24 that are supported directly by the second connector housing 30. The term “direct electrical communication” refers to electrically conductive communication due to direct physical touching.

Further, in some examples, the first electrical connector 22 is configured to mate with the second electrical connector 24 along the longitudinal direction, such that no grounds of the first electrical connector 22 overlap with any ground of the second electrical connector 24 in the plane that is oriented perpendicular to the longitudinal direction. Thus, the plane that is oriented perpendicular to the longitudinal direction does not intersect both a ground of the first electrical connector 22 and a ground of the second electrical connector 24. Further still, in some examples, the first electrical connector 22 has no grounds that are in electrical communication with any grounds of the second electrical connector 24 when the first and second electrical connectors 22 and 24 are mated with each other.

As described in more detail below, the electrical connector system 20, or one of the first and second electrical connectors 22 and 24, can include a ground member in the form of a third or auxiliary electrical shield 54 (see FIG. 1F) that places the first and second shields 44 and 46 in electrical communication with each other. The first and second shield mating portions 44b and 46b can be configured to contact the third electrical shield 54 so as to place the first and second electrical shields 44 and 46 in electrical communication with each other.

The first electrical connector 22 and the second electrical connector 24 can be hermaphroditic. In particular, the first electrical connector 22 and the second electrical connector 24 can be two visually identical parts, with one of the two visually identical parts rotated 180 degrees about the longitudinal direction L. The first and second electrical shields 44 and 46 can have substantially equal heights in the transverse direction T, substantially equal widths along the lateral direction A, and the first length L1 can be substantially equal to the second length L2.

Referring to FIG. 1E, the electrical connector system 20 can further include a sealing gasket 52 that is positioned between the first shield 44 and the second shield 46 along the longitudinal direction L. The sealing gasket can be disposed in the gap 53. Thus, the sealing gasket 52 can be positioned where the first shield 44 and the second shield 46 are butt coupled to one another. The sealing gasket 52 can extend from the first shield 44 to the second shield 46. For instance, the sealing gasket 52 can extend from the first mounting portion 44a of the first shield 44 to the second mounting portion 46a of the second shield 46. The sealing gasket 52 can be sandwiched, compressed, or biased between the first shield 44 and the second shield 46. Further, the sealing gasket 52 can at least partially or fully surround the respective first and second mating portions 34a and 36a when the electrical connectors 22 and 24 are mated with each other. The sealing gasket 46 can be configured as an elastomeric electromagnetic interference (EMI) gasket in some examples. The sealing gasket 52 can be one or more or any combination of two or more of elastomeric, electrically conductive elastomeric, physically compressible and electrically conductive, electrically conductive, thermally conductive, non-electrically conductive, non-thermally conductive, magnetic absorbing, or the like. The gasket 52 can extend from the first electrical shield 44 to the second electrical shield 46, or be positioned between the first electrical shield 44 and the second electrical shield 46, or can be electrically, physically or electrically and physically connected to each of the first electrical shield 44 and the second electrical shield 46.

The gasket 52, when electrically conductive, can shorten the ground or reference or return path between the first and second electrical shields 44, 46. The gasket 52 can reduce near-end crosstalk (NEXT), far-end crosstalk (FEXT) or both compared one or both of the first and second electrical shields 44, 46 being devoid of the gasket 52. In other examples, the electrical connector system 20 does not include the gasket 52. When the electrical conductors of the first and second electrical connectors 22 and 24 define differential signal pairs, and the first and second electrical connectors 22 and 22 are retained in an assembly housing 102 (see FIG. 3) that is made from a polymer, such as a liquid crystal polymer (LCP), the simulated FEXT and NEXT each stay below −60 dB at data transfer frequencies through approximately 15 GHz, the simulated FEXT and NEXT each stay below −60 dB at data transfer frequencies up to approximately 15 GHz when the electrical connector system 20 does not include the gasket 52. In the same gasketless, differential electrical connector systems 20, but in an assembly housing 102 made from a magnetic absorbing material, simulated FEXT and NEXT each stay below −60 dB at data transfer frequencies through approximately 80 GHz. However, it is recognized that magnetic absorbing material is expensive. A cost-effective electrical connector system 20 can be carried by the housing 102 made from LCP and can included the gasket 52 in the manner described above. Simulated FEXT and NEXT remain below −60 dB at data transfer frequencies through approximately 72 GHz.

Referring now to FIGS. 1F-1G, and as described above, the electrical connector system 20 can further include an auxiliary or third electrical shield 54. The third electrical shield 54 can be electrically conductive. For instance, the third electrical shield 54 can be metallic. Alternatively or additionally, the third electrical shield 54 can include a magnetic absorbing material, such as a lossy material. In some examples, the third electrical shield 54 can be made from copper, a noble metal, a metal alloy, any combination of copper, a noble metal and a metal alloy, electrically conductive carbon or any electrically conductive or magnetic absorbing material.

The third shield 54 can be carried or supported by the each of the first electrical shield 44 and the second electrical shield 46. The third electrical shield 54 can have a third length L3 along the longitudinal direction L. The third length L3 can span a portion of the first electrical shield 44, a portion of the second electrical shield 46, and the sealing gasket 52. The third length L3 can be greater in length than either one of or both of the first length L1 or the second length L2, or approximately equal in length to the sum of the first length L1 and second length L2. The terms “approximate,” “substantial,” derivatives thereof, and words of similar import used with reference to a direction, size, shape, dimension, or other parameter include the stated direction, size, shape, dimension, or other parameter and a range of +/−10% of the stated direction, size, shape, dimension, or other parameter, such as +/−9% of the stated direction, size, shape, dimension, or other parameter, such as +/−8% of the stated direction, size, shape, dimension, or other parameter, such as +/−7% of the stated direction, size, shape, dimension, or other parameter, such as +/−6% of the stated direction, size, shape, dimension, or other parameter, such as +/−5% of the stated direction, size, shape, dimension, or other parameter, such as +/−4% of the stated direction, size, shape, dimension, or other parameter, such as +/−3% of the stated direction, size, shape, dimension, or other parameter, such as +/−2% of the stated direction, size, shape, dimension, or other parameter, such as +/−1% of the stated direction, size, shape, dimension, or other parameter.

In one example, the third electrical shield 54 can contact, either directly or indirectly, each of the first electrical shield 44 and the second electrical shield 46, and in this regard can place the first electrical shield 44 in electrical communication with the second electrical shield 46. In one example, the third shield 54 can physically contact each of the first and second shields 44 and 46, thereby placing the first and second shields 44 and 46 in electrical communication with each other. The third electrical shield 54 can be configured as a third sleeve 56 that defines a third internal void 57 sized to receive therein the first and second electrical shields 44 and 46. In one example, the third electrical shield 54 can removably receive either or both of the first and second electrical shields 44 and 46 in the third internal void 57. The third internal void 57 can define a first portion 57a configured to receive the first electrical shield 44, and a second portion 57b configured to receive the second electrical shield 46. Thus, the first and second electrical shields 44 and 46 can be inserted into the third electrical shield 54 in opposite directions that are defined by the longitudinal direction L. The third electrical shield 54 can define a third tubular cross-sectional shape, a square cross-sectional shape having rounded corners, a rectangular cross-sectional shape having rounded corners, a circular cross-sectional shape, a rectangular cross-sectional shape, a square cross-sectional shape, or any suitable alternative cross-sectional shape.

The third electrical shield 54 can define a first, third shield mating portion 55a that is configured to mate with the first electrical shield 44, and a second, third shield mating portion 55b that is configured to mate with the second electrical shield 46. In particular, the third sleeve 56 can define a third internal surface 58 that defines the third internal void 57, and a third external surface 63 opposite the third internal surface 58. The third internal surface 58 can also define the first and second, third shield mating portions 55a and 55b. The first, third shield mating portion 55a can be opposite the second, third shield mating portion 55b along the longitudinal direction L.

Thus, the first, third shield mating portion 55a can receive the first shield 44 such that the first external surface 60 of the first shield 44 is electrically, physically or both electrically and physically connected to the internal surface 58 of the third shield 54. Similarly, the second, third shield mating portion 55b can receive the second shield 46 such that the second external surface 62 of the second shield 46 is electrically, physically or both electrically and physically connected to the internal surface 58 of the third shield 54.

The first and second shields 44 and 46 can be at least partially surrounded on at least three sides by the third shield 54 along all or any portion of the third length L3 of the third shield 54. In one example, the first and second shields 44 and 46 can be surrounded on all sides along all or any portion of third length L3 of the third shield 54. Thus, in respective planes that are oriented perpendicular to the longitudinal direction L and intersect the first and second shields 44 and 46, the third shield 54 can define respective third perimeters that fully circumscribe or surround the first and second electrical shields 44 and 46. In some examples, the first and second shields 44 and 46 can be surrounded all sides by the third shield 54. Thus, at least a portion up to an entirety of a first conductor length of the at least one first electrical signal conductor 28 along the longitudinal direction L can be surrounded by a combination of the first electrical shield 44 and the third electrical shield 54. Similarly, at least a portion up to an entirety of a second conductor length of the at least one second electrical signal conductor 32 along the longitudinal direction L can be surrounded by a combination of the second electrical shield 44 and the third electrical shield 54.

In one example, the third shield 54 can include a respective at least one contact member 64 that projects inward toward either or both of the first and second electrical shields 44 and 46, and is configured to mate either or both of the first and second electrical shields 44 and 46. The contact member 64 can project inward along a direction that is defined from the third external surface 63 to the third internal surface 58. The at least one contact member 64 can be disposed at either or both of the first, third shield mating portion 55a and the second, third shield mating portion 55b. The contact member 64 can be configured in any suitable manner as desired. For instance, the contact member 64 can be configured as one or more spring fingers 66 that project inward along from the third internal surface 58. The spring fingers 66 can be resilient and deflectable. Thus, when the third shield 54 receives the respective at least one of the first and second electrical connectors 22 and 24, the spring finger 66 can resiliently deflect outward as it contacts the respective at least one of the first and second electrical shields 44 and 46. The spring finger 66 thus provides a spring force against the respective at least one external surface of the first and second electrical shields 44 and 46 so as to maintain contact when the at least one of the first and second electrical shields 44 and 46 is received by the third shield 54. The third shield 54 can include any number of spring fingers 66, such as at least one, at least two, at least three, at least four, or four or more spring fingers 66.

In another example, the third shield 54 can include at least one embossment that projects inward so as to contact a respective one of the first and second electrical shields 44 and 46. Each embossment 68 can define a projection 70 that extends inward from the third internal surface 58. Each embossment 68 can define a corresponding recess that extends into the third external surface 63. Thus, each embossment 68 can be stamped into the third shield 54. The projections 70 can a friction fit against the respective at least one of the first and second electrical shields 44 and 46. Accordingly, the embossment 68 can maintain contact against the respective at least one external surface of the first and second electrical shields 44 and 46 so as to maintain contact when the at least one of the first and second electrical shields 44 and 46 is received by the third shield 54. The third shield 54 can include any number of embossments 68 as desired.

In one example, the third shield 54 can include the spring fingers 66 that contact the first external surface 60 of the first electrical shield 44 when the third shield 54 receives the first electrical shield 44 in the first portion 57a of the third internal void 57. The third shield 54 can further include the embossments 68 that contact the second external surface 62 of the second electrical shield 46 when the third shield 54 receives the second electrical shield 46 in the second portion 57b of the third internal void 57.

In some examples, the first electrical connector 22 can include the third shield 54 that is attached to the first electrical shield 44. For instance, the third shield 54 can be welded or the like to the first electrical shield 44. Thus, the second electrical shield 46 is placed in contact with the third shield 54 when the second electrical connector 24 is mated with the first electrical connector 22. The third electrical shield 54 can remain coupled to the first electrical shield 44 when the second electrical connector 24 is unmated from the first electrical connector 22. In this regard, the third electrical shield 54 can be referred to as an auxiliary electrical shield of the first electrical connector 22. Thus, the first electrical connector 22 can include the first electrical shield 44 and the third electrical shield 54. Alternatively, the first electrical shield 44 and the third electrical shield 54 can be defined by one single unitary monolithic electrical shield.

In other examples, the second electrical connector 24 can include the third shield 54 that is attached to the second electrical shield 46. For instance, the third shield 54 can be welded or the like to the second electrical shield 46. In one example, the second electrical shield 46 can include recesses that receive respective ones of the embossments 68 so as to interlock the third electrical shield 54 with the second electrical shield 46. The first electrical shield 44 is placed in contact with the third shield 54 when the first electrical connector 22 is mated with the second electrical connector 24. The third electrical shield 54 can remain coupled to the second electrical shield 44 when the first electrical connector 22 is unmated from the second electrical connector 24. In this regard, the third electrical shield 54 can be referred to as an auxiliary electrical shield of the second electrical connector 24. Thus, the second electrical connector 24 can include the second electrical shield 46 and the third electrical shield 54. Alternatively, the second electrical shield 46 and the third electrical shield 54 can be defined by one single unitary monolithic electrical shield. In one example, the first electrical shield 44, the second electrical shield 46, and the third electrical shield 54 define all ground members of the electrical connector system 20.

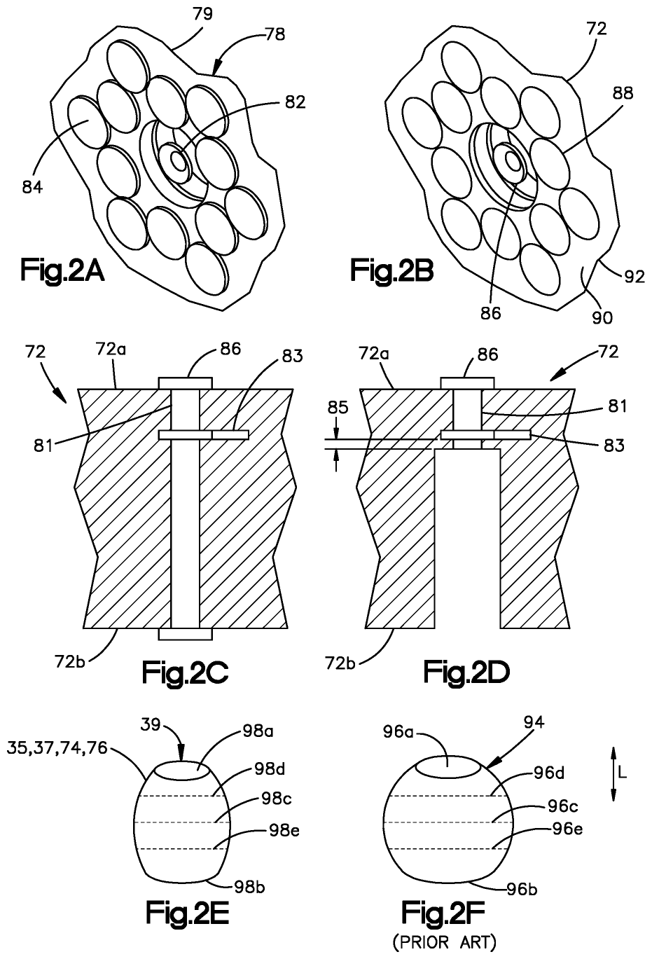

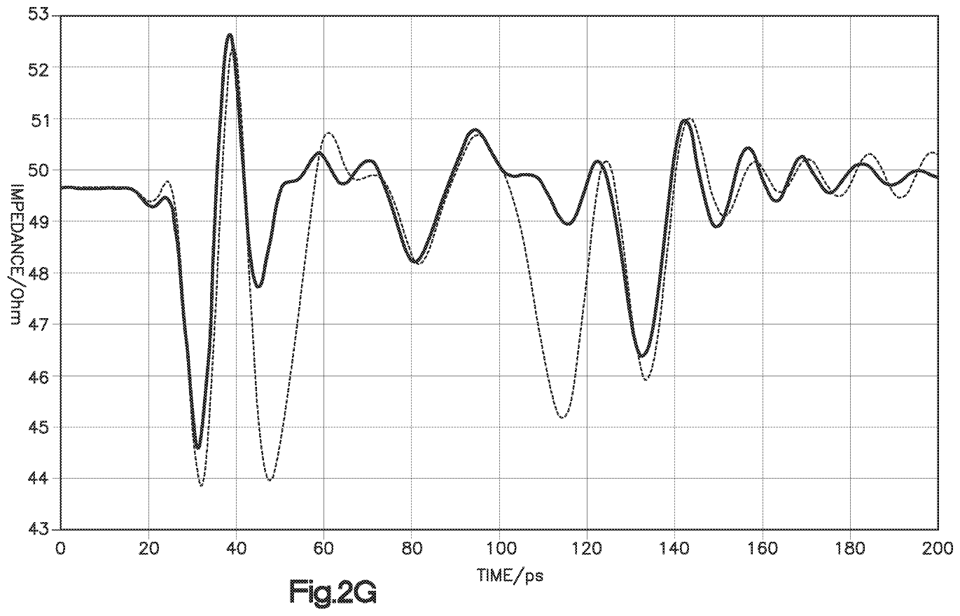

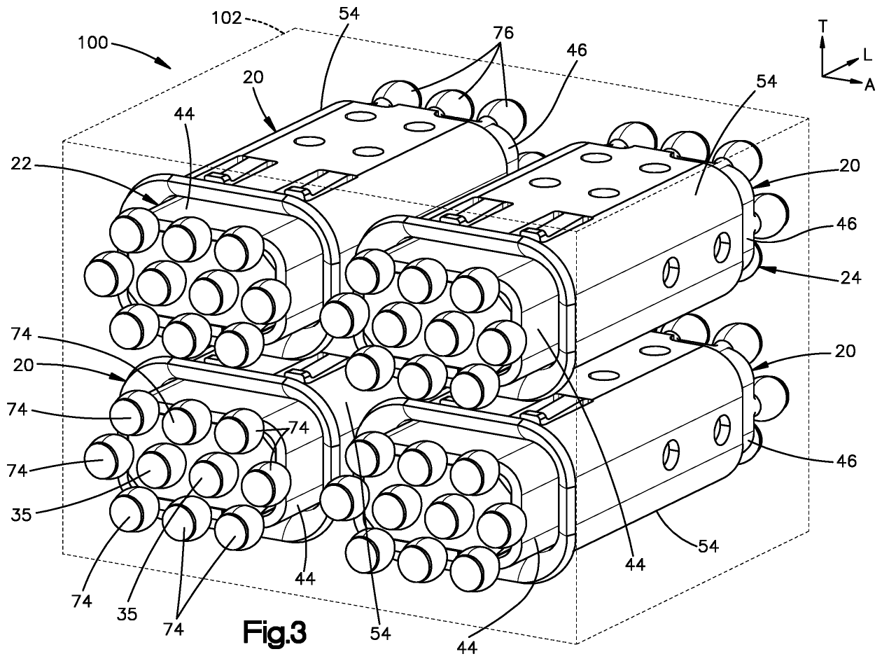

The first and second electrical connectors 22 and 24 can be configured to be mounted to underlying substrates 72 as described in more detail below with reference to FIG. 2B. As described above, each of the first electrical conductors 28 can be attached to the respective first electrical signal conductor SMT attachment 35. Each of the second electrical conductors 32 can be attached to the respective second electrical signal conductor SMT attachment 37. Further, the first shield mounting portion 44a of the first electrical shield 44 can be attached to a respective at least one first shield SMT attachment 74. For instance, the first electrical shield 44 can be attached to a plurality of first shield SMT attachments 74. In one example, the first shield mounting portion 44a can each define a plurality of first mounting pins that each attach to a corresponding one of the respective first shield SMT attachments 74. Similarly, the second shield mounting portion 46a of the second electrical shield 46 can be attached to a respective at least one second shield SMT attachment 76. For instance, the second electrical shield 46 can be attached to a plurality of second shield SMT attachments 76. In one example, the second shield mounting portion 46a can carry a plurality of second mounting pins that each attach to a corresponding one of the respective second shield SMT attachments 76. In one example, the first and second shield SMT attachments 74 and 76 can be configured as solder balls 39.

Referring now to FIG. 1B in particular, the first shield SMT attachments 74 define grounds and can surround either or both of the at least one first electrical signal conductor SMT attachment 35 and the at least one first conductor mounting portion 34b. In particular, the first shield SMT attachments 74 define respective geometric centers that lie substantially in a first shield SMT center plane that is oriented perpendicular to the longitudinal direction L. When straight lines are drawn that connect adjacent ones of the geometric centers of the first shield SMT attachments 74 to each other in the first shield SMT center plane, the straight lines combine to define a first shield outer perimeter, wherein each of the first shield SMT attachments 74 defines a node of the first shield outer perimeter. The first nodes can be substantially equidistantly spaced about the first shield outer perimeter. Alternatively, the first nodes can be variably spaced about the first shield outer perimeter as desired.

The at least one first electrical signal conductor SMT attachment 35 similarly defines a respective at least one geometric center that lies substantially in a first electrical signal conductor SMT center plane that is oriented perpendicular to the longitudinal direction L. In one example, the first shield SMT center plane is coincident with the first electrical signal conductor SMT center plane so as to define a first common plane with the first electrical signal conductor SMT center plane. The first shield outer perimeter surrounds the at least one geometric center of the at least one first electrical signal conductor SMT attachment 35 in the common plane. It is recognized in other examples that the first shield SMT center plane can be offset from the first electrical signal conductor SMT center plane along the longitudinal direction L. In this example, when the first shield SMT center plane is mapped onto the first electrical signal conductor SMT center plane so as to define a first combined plane with the first shield SMT center plane, the first shield outer perimeter surrounds the at least one geometric center of the at least one first electrical signal conductor SMT attachment 35 in the combined plane. The first electrical shield 44 can carry at least two, at least three, at least four, at least five, at least six, at least seven or at least eight respective first shield SMT attachments 74 as desired that can surround or at least partially surround the at least one, such as at least two, first electrical signal conductor SMT attachments 35.

Similarly, the at least one first conductor mounting portion 34b defines a respective at least one geometric center that lies substantially in a first conductor mounting portion plane that is oriented perpendicular to the longitudinal direction L. In one example, the first shield SMT center plane is coincident with the first conductor mounting portion plane so as to define a first common plane with the first conductor mounting portion plane. The first shield outer perimeter surrounds the at least one geometric center of the at least one first conductor mounting portion 34b in the common plane. It is recognized in other examples that the first shield SMT center plane can be offset from the first conductor mounting portion plane along the longitudinal direction L. In this example, when the first shield SMT center plane is mapped onto the first conductor mounting portion plane so as to define a first combined plane with the first conductor mounting portion plane, the first shield outer perimeter surrounds the at least one geometric center of the at least one first conductor mounting portion 34b in the combined plane.

Referring now to FIG. 1C in particular, the second shield SMT attachments 76 that define grounds and can surround either or both of the at least one second electrical signal conductor SMT attachment 37 and the at least one second conductor mounting portion 36b. In particular, the second shield SMT attachments 76 define respective geometric centers that lie substantially in a second shield SMT center plane that is oriented perpendicular to the longitudinal direction L. When straight lines are drawn that connect adjacent ones of the geometric centers of the second shield SMT attachments 76 to each other in the second shield SMT center plane, the straight lines combine to define a second shield outer perimeter, wherein each of the second shield SMT attachments 76 defines a second node of the second shield outer perimeter. The second nodes can be substantially equidistantly spaced about the second shield outer perimeter. Alternatively, the second nodes can be variably spaced about the second shield outer perimeter as desired.

The at least one second electrical signal conductor SMT attachment 37 similarly defines a respective at least one geometric center that lies substantially in a second electrical signal conductor SMT center plane that is oriented perpendicular to the longitudinal direction L. In one example, the second shield SMT center plane is coincident with the second electrical signal conductor SMT center plane so as to define a second common plane with the second electrical signal conductor SMT center plane. The second shield outer perimeter surrounds the at least one geometric center of the at least one second electrical signal conductor SMT attachment 37 in the common plane. It is recognized in other examples that the second shield SMT center plane can be offset from the second electrical signal conductor SMT center plane along the longitudinal direction L. In this example, when the second shield SMT center plane is mapped onto the second electrical signal conductor SMT center plane so as to define a second combined plane with the second shield SMT center plane, the second shield outer perimeter surrounds the at least one geometric center of the at least one second electrical signal conductor SMT attachment 37 in the combined plane.

Similarly, the at least one second conductor mounting portion 36b defines a respective at least one geometric center that lies substantially in a second conductor mounting portion plane that is oriented perpendicular to the longitudinal direction L. In one example, the second shield SMT center plane is coincident with the second conductor mounting portion plane so as to define a second common plane with the second conductor mounting portion plane. The second shield outer perimeter surrounds the at least one geometric center of the at least one second conductor mounting portion 36b in the common plane. It is recognized in other examples that the second shield SMT center plane can be offset from the second conductor mounting portion plane along the longitudinal direction L. In this example, when the second shield SMT center plane is mapped onto the second conductor mounting portion plane so as to define a second combined plane with the second conductor mounting portion plane, the second shield outer perimeter surrounds the at least one geometric center of the at least one second conductor mounting portion 34b in the combined plane. The second electrical shield 46 can carry at least two, at least three, at least four, at least five, at least six, at least seven or at least eight respective first shield SMT attachments 76 as desired that can surround or at least partially surround the at least one, such as at least two, first electrical signal conductor SMT attachments 35.

Referring now also to FIGS. 2A-2G, the SMT attachments 35, 37, 74, and 76 can be configured to improve the impedance of the electrical connector system 20. That is, the electrical connector system 20 can achieve SMT improvements that render measured or simulated impedance closer to a desired impedance. As described above, each of the first and second electrical connectors 22 and 24 can be mounted to respective substrates. In particular, the at least one first electrical signal conductor SMT attachment 35 can be mounted to a respective at least one electrical signal contact pad of a first substrate. Similarly, the first shield SMT attachments 74 can be mounted to respective ones of a plurality of electrical ground contact pads of the first substrate. Similarly, the at least one second electrical signal conductor SMT attachment 37 can be mounted to a respective at least one electrical signal contact pad of a second substrate. Similarly, the second shield SMT attachments 76 can be mounted to respective ones of a plurality of electrical ground contact pads of the second substrate. The first and second substrates can be configured as the substrate 72.

As illustrated in FIG. 2A, the substrate 78 includes a dielectric layer 79 such as FR4, at least one electrical signal contact pad 82, and a plurality of electrical ground contact pads 84. The ground contact pads 84 can be supported by the dielectric layer 79. The at least one electrical signal contact pad 82 can be disposed in a respective anti-pad so as to electrically isolate the at least one electrical signal contact pad 82 from the ground layer.

Referring now to FIG. 2B, the substrate 72 can include at least one electrical signal contact pad 86 and a plurality of electrical ground contact pads 88. The contact pads 86 and 88 can be referred to as SMT contact pads that are configured to secure to SMT attachments 35 or 37, and 74 and 76, respectively. While one single electrical signal contact pad 86 is shown, it should be appreciated that the substrate 72 can include a pair of electrical signal contact pads 86 positioned such that the electrical signal conductor SMT attachments 35 and 37 can be mounted to respective pairs of electrical signal contact pads 86 of first and second ones of the substrate 72 when the first and second electrical connectors 22 and 24 include respective pairs of first and second electrical conductors 28 and 32. Alternatively, the first and second electrical connectors 22 and 24 can include one single respective signal conductor 28 and 32, and thus also one signal electrical signal conductor SMT attachments 35 and 37. Thus, the respective single electrical signal conductor SMT attachments 35 and 37 can be mounted the single electrical signal contact pad 86 of first and second ones of the substrate 72. The electrical ground contact pads 84 can be positioned such that respective ones of the first and second shield SMT attachments 74 and 76 can be mounted to the ground contact pads 88 of the respective first and second ones of the substrate 72.

The SMT attachments of the first and second electrical connectors 22 and 24, respectively, can be mounted to respective first sides 72a of the substrate 72 to which it is mounted. Thus, the at least one signal contact pad 86 and the electrical ground contact pads 88 can be disposed proximate the first surface 72a, and accessible from the first side 72a by the SMT attachments of the respective one of the first and second electrical connectors 22 and 24.

As illustrated in FIG. 2B, the dielectric layer 79 can be flooded with electrically conductive material 90 so as to define a ground plane 92 that encompasses and surrounds the electrical ground contact pads 88 such that external surfaces to which the ground SMT attachments are mounted can be substantially flush with the electrically conductive material. The electrically conductive material 90 can further place the electrical ground contact pads 88 in electrical communication with each other. In one example, the dielectric layer 79 can be flooded with approximate 0.7 mm to 0.8 mm of electrically conductive material 90.

Referring now to FIGS. 2C-2D, a method can be provided for reducing a pad via stub of a conventional substrate 78 to produce a substrate 72 such as a printed circuit board (PCB) having reduced the pad via stub length SL. In particular, the substrate 72 defines the at least one electrical signal contact pad 86, and a corresponding at least one electrical signal via 81 that extends from the at least one electrical signal contact pad 86 to a signal trace 83 of the substrate 72. In some examples, the at least one electrical signal via 81 can extend from the at least one electrical signal contact pad 86 to a second side 72b of the substrate 72 that is opposite the first side 72a. The signal via 81 can be removed, for instance backdrilled, from the second side 72b of the substrate 72 toward, but not to, the signal trace 83. The substrate 72, and in particular the signal via 81, can therefore define a pad via stub length 85 that extends along the longitudinal direction L from the signal trace 83 to the second side 72b of the substrate 72. It can be desirable to minimize the stub length 85, which has been known to have the undesirable effect of acting as an antenna during operation. In one example, the substrate 72 can have a pad via stub length that is half of that of the conventional substrate 78. In one example, conventional substrates can define pad via stub lengths of approximately 8 mm. The substrate 72 to which a respective one of the first and second electrical connector 22 and 24 is mounted can define pad via stub lengths in a range from approximately 0.5 mm to approximately 4 mm.

Referring now to FIG. 2E, the solder balls 39 can be more cylindrical than conventional solder balls 94 shown at FIG. 2F, which can be configured as solder balls of a NovaRay® electrical connector commercially available from SAMTEC, INC having a principal place of business in New Albany, Ind. The solder balls 39 and 94 are shown in FIGS. 2E and 2F after a reflow operation that secures the solder balls to a corresponding contact pad of an underlying substrate.

The conventional solder ball 94 defines first and second opposed ends 96a and 96b that are opposite each other along the longitudinal direction L, and a midplane 96c that is disposed substantially equidistantly between the opposed ends 96a and 96b and oriented perpendicular to the longitudinal direction. The conventional solder ball 94 further defines a first intermediate plane 96d disposed substantially equidistantly between the first end 96a and the midplane 96c, and a second intermediate plane 96e disposed substantially equidistantly between the second end 96b and the midplane 96. The conventional solder ball 94 defines a maximum width at the midplane 96c, a first width at the first intermediate plane 96d, and a second width at the second intermediate plane 96e. The first and second widths can be measured in the same direction as the maximum width. The maximum width is greater than each of the first and second widths. Thus, the reflowed conventional solder balls 94 can be said to have a convex profile.

The solder balls 39 of the electrical connector system 20 defines first and second opposed ends 98a and 98b that are opposite each other along the longitudinal direction L, and a second midplane 98c that is disposed substantially equidistantly between the opposed ends 98a and 98b and oriented perpendicular to the longitudinal direction. Each solder balls 39 further defines a first intermediate plane 98d disposed substantially equidistantly between the first end 98a and the midplane 98c, and a second intermediate plane 98e disposed substantially equidistantly between the second end 98b and the midplane 98c. Each solder ball 39 defines a maximum width at the midplane 98c, a first width at the first intermediate plane 98d, and a second width at the second intermediate plane 98e. The first and second widths can be measured in the same direction as the maximum width. The maximum width is greater than each of the first and second widths. Thus, the solder balls 39 can be said to have a convex profile. Further, the solder balls 39 can be substantially cylindrical.

The convex profile defined by the solder balls 39, when reflowed onto the substrate, has a more cylindrical shape than the convex profile defined by the reflowed conventional solder balls 96. In particular, the first and second widths of the solder balls 39 define respective ratios with respect to the maximum width of the solder balls 39 that is greater than respective ratios of the first and second widths of the conventional solder balls 94 with respect to the maximum width of the conventional solder balls. For example, solder ball 39 can have the same height as a conventional solder ball 94 of the NovaRay® vertical board electrical connector commercial available from SAMTEC, INC), but the solder ball 39 can be scaled to have a volume approximately 10-20% less than the conventional solder ball 94 of the NovaRay® vertical board electrical connector commercial available from SAMTEC, INC, such that when the solder ball 39 reflows onto a substrate it forms a barrel in cross-section verses a sphere in cross-section, like the conventional solder ball 94. The second midplane 98c can have a post-board reflow, cross-sectional length of approximately 5-30% less than midplane 96c. Similarly, the first intermediate plane 98d of the respective solder balls 39 can have a post-board reflow, cross-sectional length of approximately 5-30% less than the first intermediate plane 96d of the conventional solder ball 94. Similarly, the second intermediate plane 98e of the respective solder balls 39 can have a post-board reflow, cross-sectional length of approximately 5-30% less than the second intermediate plane 96e of the conventional solder ball 94. It has been found that solder balls that reflow to a more cylindrical shape can significantly improve impedance mismatch with respect to the conventional solder ball that reflows to a more circular shape. Thus, the impedance of the electrical connectors 22 and 24 match more closely to the desired impedance. In one example, the first and second widths of the solder balls 39 can be substantially equal to each other. Alternatively, the first and second widths of the solder balls 39 can vary as desired.

The shape of solder balls 39 can be intentionally determined by adjusting plating, adjusting connector housing standoff lengths, changing a solder ball size without change a height of the solder ball, changing the contact pad area of the underlying substrate, or widening retention portions of an electrical signal conductor at an intersection of the solder ball and the electrical signal conductor. The step of changing the solder ball size can include reducing a width and/or a depth of the solder ball, without reducing or increasing a height of the solder ball along the transverse direction T. The width can be defined by a first direction that is perpendicular to the transverse direction T, and the depth can be defined by a second direction that is perpendicular to each of the transverse direction T and the first direction. The method of any one of claims 19 to 21 further comprising a step of reducing a width and depth of a solder ball, without reducing or increasing a height of the solder ball. As shown in FIG. 2G, the SMT improvements described above, alone or in combination with each other, can improve unwanted impedance mismatch during operation of the electrical connector system 20, which can be defined as an unwanted variation between a desired impedance and an actual, measured impedance or a simulated impedance. The lighter broken line of FIG. 2G is a simulated single-ended impedance without the SMT improvements described herein, and the solid line of FIG. 2G is a simulated single-ended impedance after the SMT improvements described herein were added to the model. It has been discovered that the electrical connector system 20 can achieve approximately 85 ohms+/5 ohms or approximately 100 ohms+/−5 ohms of differential impedance.

Referring now to FIGS. 1A-1F and FIG. 3, an electrical connector assembly 100 can include an assembly housing 102 and a plurality of electrical connector systems 20 carried or otherwise supported by the assembly housing 102. In one example, at least respective portions of the electrical connector systems 20 can be disposed in the assembly housing 102. For instance, the second electrical connector 24, the second shield 46 and the third shield 54 of each electrical connector system 20 can be carried by the assembly housing 102. The assembly housing 102 can be configured as a plastic housing, an electrically conductive housing, an electrically conductive magnetic absorbing housing, or an electrically non-conductive magnetic absorbing housing. Thus, the assembly housing 102 can at least partially surround the second shield 46 and the third shield 54. The first electrical connector 22 and the first shield 44 of each electrical connector system 20 can be carried by the housing 102, which can be plastic, an electrically conductive and magnetic absorbing, or an electrically non-conductive and magnetic absorbing. Thus, the assembly housing 102 can at least partially surround the first shield 44 and the third shield 54. As illustrated in FIG. 3, four electrical connector systems 20 can be supported by the assembly housing 102. It should be appreciated, of course, that the electrical connector assembly 100 can include any number of electrical connector systems 20 supported by the assembly housing 102 as desired.

It should be appreciated that the electrical connector systems 20 can each be referred to as a respective twinaxial electrical system that includes first twin axial, differential signal electrical connector 22 mated to a second twin axial, differential signal electrical connector 24. In this regard, the respective pair of first signal conductors 28 of the first electrical connectors 22 can define respective differential signal pairs that are electrically shielded by at least one ground that can be defined by the first and third electrical shields 44 and 54. Similarly, the respective pair of second signal conductors 32 of the second electrical connectors 24 can define respective second differential signal pairs that are electrically shielded by at least one ground in that can be defined by the second and third electrical shields 46 and 54. Each electrical connector system 20 can be physically independent of another, and can be physically spaced apart from one another along a plane that is oriented perpendicular to the longitudinal direction L. Each first shield 44 does not share a common wall with another immediately adjacent first shield 44 of an immediately adjacent first electrical connector 22. Each second shield 46 does not share a common wall with another immediately adjacent second shield 46 of an immediately adjacent second electrical connector 24. Each third shield 54 does not share a common wall with another immediately adjacent third shield 54 of an immediately adjacent electrical connector system 20. It should be appreciated that one or more first electrical signal conductor SMT attachments 74 can be eliminated, along with its associated solder pin carried by the first shield mounting portion 44a, to facilitate substrate routing. Similarly, one or more second electrical signal conductor SMT attachments 76 can be eliminated, along with its associated solder pin carried by the second shield mounting portion 46a, to facilitate substrate routing.

As described above with respect to FIGS. 1A-1F, the first electrical connector 22 can include at least one first electrical signal conductor 28 that can be configured as a pair of first signal conductors 28. Further, the second electrical connector 24 can include at least one second electrical signal conductor 32 that can be configured as a pair of second signal conductors 32. However, referring now to FIGS. 4A-4B, the first electrical connector 22 can alternatively include a single first electrical signal conductor 28 that can be a first single-ended signal conductor. Similarly, the second connector 24 can alternatively include a single second electrical signal conductor 32 that can be a second single-ended signal conductor. In this regard, the electrical connector systems 10 can be referred to as single-ended connector systems. Further, the electrical connector systems 10 can be referred to as coaxial electrical systems, whereby the respective first and second electrical connectors 22 and 24 define coaxial electrical connectors whose respective single electrical conductors 28 and 32 surrounded by respective shields 44 and 46. When the first electrical connector 22 is mounted to a respective one of the substrates 72, the substrate 72 can be configured as a coaxial substrate whose contact pads are SMT contact pads that secure to SMT attachments 35 and 74. When the second electrical connector 24 is mounted to a respective one of the substrates 72, the substrate 72 can be configured as a coaxial substrate whose contact pads define SMT contact pads that secures to SMT attachments 37 and 76. The first and second electrical signal conductors 28 and 32 illustrated in FIGS. 4A-4B can be single ended or can define radiofrequency (RF) conductors. The first and second electrical connectors 22 and 24 of FIG. 4A can be carried by our otherwise supported in a respective assembly housing 102 (see FIG. 3) so as to define an electrical connector assembly 100 in the manner described above.

As described above, the electrical shields 44 of the first electrical connector can carry a plurality of first shield SMT attachments 74, such as at least two, at least three, at least four, at least five, or at least six respective first shield SMT attachments 74 that define grounds. The first shield SMT attachments 74 can surround either or both of the electrical signal conductor SMT attachment 35 and the first conductor mounting portion 34b of the first electrical signal conductor 28, in the manner described above. Further, the first shield SMT attachments 74 can define a first shield outer perimeter that surrounds the electrical signal conductor SMT attachment 35 and the first conductor mounting portion 34b of the first electrical signal conductor 28, in the manner described above. The first nodes defined by the first shield SMT attachments 74 can be substantially equidistantly spaced about the first shield outer perimeter. Alternatively, the first nodes can be variably spaced about the first shield outer perimeter as desired.

Similarly, as described above, the second electrical shields 46 of the second electrical connector 24 can carry a plurality of second shield SMT attachments 76, such as at least two, at least three, at least four, at least five, or at least six respective first shield SMT attachments 76 that define grounds. The second shield SMT attachments 76 can surround either or both of the second electrical signal conductor SMT attachment 37 and the second conductor mounting portion 36b of the second electrical signal conductor 32, in the manner described above. Further, the second shield SMT attachments 76 can define a second shield outer perimeter that surrounds the second electrical signal conductor SMT attachment 37 and the second conductor mounting portion 36b of the second electrical signal conductor 32, in the manner described above. The second nodes defined by the second shield SMT attachments 76 can be substantially equidistantly spaced about the second shield outer perimeter. Alternatively, the second nodes can be variably spaced about the second shield outer perimeter as desired. It should be appreciated that one or more first electrical signal conductor SMT attachments 74 can be eliminated, along with its associated solder pin carried by the first shield mounting portion 44a, to facilitate substrate routing. Similarly, one or more second electrical signal conductor SMT attachments 76 can be eliminated, along with its associated solder pin carried by the second shield mounting portion 46a, to facilitate substrate routing.

Each of the electrical connector systems 20 of FIG. 4A can be independent of another, and are each physically spaced apart from one another. Each first shield 44 does not share a common wall with another immediately adjacent first shield 44 of an immediately adjacent first electrical connector 22. Each second shield 46 does not share a common wall with another immediately adjacent second shield 46 of an immediately adjacent second electrical connector 24. Each third shield 54 does not share a common wall with another immediately adjacent third shield 54 of an immediately adjacent electrical connector system 20. Each first conductor mating portion 34a and each second conductor mating portion 36a can be solid as described above with respect to FIGS. 1A-1F or bifurcated as described above with respect to FIG. 4B.

It has been found that each of the first and second electrical connectors 22 and 24 having single-ended or differential signal conductors can be cable of transmitting signals at frequencies up to approximately 75 GHz, including up to 67 GHz, with no worse than approximately −60 dB of unwanted cross-talk. Further, each of the first and second electrical connectors 22 and 24 having single-ended or differential signal conductors can be cable of transmitting signals at frequencies up to approximately 75 GHz, including up to 67 GHz, with insertion losses no worse than a range from 0 dB through approximately −3 dB.

Although board-to-board connectors are shown, one or both of the first electrical connector 22 and the second electrical connector 24 can be cabled differential signal pair connectors, cabled single-ended connectors, right angled connectors, cabled single-ended connectors, or RF connectors.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1. An electrical connector system comprising:
at least one first electrical signal conductor surrounded on at least three sides by a first electrical shield;
at least one second electrical signal conductor surround on at least three sides by a second electrical shield; and
a third electrical shield that surrounds at least three sides of the first electrical shield and at least three sides of the second electrical shield.

2. The electrical connector system of claim 1 wherein the first electrical signal conductor comprises a first conductor mating portion and a first conductor mounting portion.

3. The electrical connector system of claim 1, wherein the second electrical signal conductor comprises a second conductor mating portion and a second conductor mounting portion.

4. The electrical connector system of claim 1, wherein the first electrical shield comprises a first shield mounting portion and a first shield mating portion.

5. The electrical connector system of claim 1, wherein the second electrical shield comprises a second shield mounting portion and a second shield mating portion.

6. The electrical connector system of claim 1, further comprising an elastomeric gasket disposed between the first electrical shield and the second electrical shield.

7. The electrical connector system of claim 1, wherein the first electrical shield has a first tubular shape.

8. The electrical connector system of claim 1, wherein the second electrical shield has a second tubular shape.

9. The electrical connector system of claim 1, wherein the third electrical shield has a third tubular shape.

10. The electrical connector system of claim 1, wherein the third electrical shield comprises a first, third shield mating portion and a second, third shield mating portion.

11. The electrical connector system of claim 1, wherein the third electrical shield receives the first electrical shield and the second electrical shield.

12. The electrical connector system of claim 1, wherein the first electrical signal conductor comprises a first length that is surrounded by a combination of the first electrical shield and the third electrical shield.

13. The electrical connector system of claim 1, wherein the second electrical signal conductor comprises a second length that is surrounded by a combination of the second electrical shield and the third electrical shield.

14. The electrical connector system of claim 1, further comprising a housing that at least partially surrounds the first electrical shield and the third electrical shield.

15. The electrical connector system of claim 1, further comprising a solder ball attached to the first electrical signal conductor, wherein the solder ball, when reflowed onto a substrate, has a substantially cylindrical cross-sectional shape.

16. The electrical connector system of claim 1, wherein the first electrical shield and the second electrical shield are butt coupled at one of their respective ends.

17. The electrical connector of claim 16, further comprising a sealing gasket positioned where the first electrical shield and the second electrical shield are each butt coupled to one another.

18. An electrical connector comprising single-ended or differential signal conductors configured to transmit signals at frequencies up to approximately 75 GHz with no worse than approximately −60 dB of cross-talk.

19. The electrical connector of claim 18, configured to transmit signals at frequencies up to approximately 75 GHz with insertion loss no worse than a range from 0 dB to approximately −3 dB.

20. A first electrical connector comprising:
a first connector housing;
at least one first electrical signal conductor supported by the first connector housing; and
a first electrical shield that receives the first connector housing and surrounds at least three sides of the at least one first electrical signal conductor,
wherein the first electrical connector is configured to mate with a second electrical connector along a longitudinal direction, such that no grounds of the first electrical connector overlap with any ground of the second electrical connector in a plane that is oriented perpendicular to the longitudinal direction.

21. The first electrical connector of claim 20, further configured to mate with the second electrical connector such that no grounds of the first electrical connector touch any grounds of the second electrical connector.

22-24. (canceled)

25. An electrical connector comprising at least one first electrical signal conductor surrounded on at least three sides by a first electrical shield,
wherein the electrical connector is configured to mate with a second electrical connector, such that an auxiliary electrical shield contacts both the first electrical shield and a second electrical shield of the second electrical connector.

26. The electrical connector of claim 25, wherein the auxiliary electrical shield receives the first electrical shield and the second electrical shield

27. The electrical connector of claim 25, wherein the auxiliary electrical shield is attached to the first electrical shield.

28. The electrical connector of claim 25, wherein the auxiliary electrical shield and the first electrical shield define a unitary structure.

29-33. (canceled)
